(19) United States
(12) Patent Application Publication
(10) Pub. No.: US 2006/0106531 A1
(43) Pub. Date: May 18, 2006

(54) Information gathering systems, methods, and programs

(75) Inventors: Kenji Nagase, Okazaki-shi (JP); Kazutaka Yoshikawa, Okazaki-shi (JP); Toshiaki Minami, Okazaki-shi (JP); Hiroshi Tomita, Okazaki-shi (JP); Masao Kawai, Okazaki-shi (JP)

Correspondence Address: OLIFF & BERRIDGE, PLC, P.O. BOX 19928, ALEXANDRIA, VA, 22320, US

(73) Assignee: Aisin AW Co., Ltd., Anjo-shi (JP)

(21) Appl. No.: 11/254,724

(22) Filed: Oct. 21, 2005

(30) Foreign Application Priority Data
Nov. 12, 2004 (JP) 2004-328637
Nov. 17, 2004 (JP) 2004-333329

(51) Int. Cl. G01C 21/36

(52) U.S. Cl. 701/200

(57) ABSTRACT

Information gathering systems, methods, and programs transmit a request for other-vehicle drive information to an information center; and as a result of the transmitted request, only receive other-vehicle drive information of vehicles that are within a predetermined area, the predetermined area set based on the present location. Information gathering systems, methods, and programs determine whether a link corresponding to a present location is subject for gathering drive information and, if the link corresponding to the present location is subject for gathering the drive information, gather the drive information for that link.

### INCORPORATION BY REFERENCE

The disclosure of Japanese Patent Application No. 2004-328637 filed on Nov. 12, 2004 and 2004-333329 filed on Nov. 17, 2004 including the specifications, drawings and abstracts are incorporated herein by reference in their entirety.

### BACKGROUND

1. Related Technical Fields

Related technical fields include information gathering systems, methods, and programs.

2. Related Art

In a conventional navigation apparatuses, for example, a present position of a vehicle is detected by a global positioning system (GPS), and a direction of the vehicle is detected on the basis of the turning angle of the vehicle detected by a gyro sensor. Map data is read out from a memory, and a map screen is formed in a display portion. The vehicle's present position, a map around the vehicle position, and the vehicle's direction are displayed on the map screen. Therefore, a driver can drive the vehicle in accordance with the vehicle's position, the map, and the vehicle's direction, which are displayed on the map screen.

When the driver inputs a destination and sets search conditions, routes from the present location to the destination are searched for in accordance with the map data on the basis of the search conditions. Then, while the vehicle is being driven, a searched route is displayed together with the vehicle's position on the map screen. Therefore, the driver can drive the vehicle along the search route displayed.

In conventional navigation apparatuses, a travel route representing a route taken during the drive of the vehicle, travel time information representing the time of passage of the vehicle through various points are sent to a control center. The control center gathers the travel route and the travel time information and performs statistical processes on the travel route and the travel time information, and computes the traffic congestion of roads, computes the required travel time from the starting location to the destination. The control center provides the state of traffic congestion of roads and the required travel time that have been computed for other vehicles (see, e.g., Japanese Patent Application Laid-Open Publication No. 2002-150467).

### SUMMARY

In the foregoing conventional navigation apparatuses, the travel routes and the travel time information are gathered, irrespective of whether the traffic congestion of roads and the required time that are provided will be utilized by a driver of another vehicle. Therefore, the communication expense for transmission of travel routes, travel time information, etc. to the control center becomes high. Thus, the cost for information gathering becomes high. In addition, unnecessary communications are executed.

Furthermore, in the foregoing conventional navigation apparatuses, the travel routes, the travel time information, etc. with regard to all the roads where the vehicles are driven, are transmitted to the control center. Therefore, the communication expense becomes high. Furthermore, the amount of calculation for performing the statistical processes at the control center becomes large, so that a high-performance processing device is needed. Thus, the cost for information gathering becomes high.

If the travel routes, the travel time information, etc. are to be gathered in real time with regard to all the roads, there arises a need to gather the travel routes, the travel time information, etc. from a very large number of vehicles. Therefore, the cost for information gathering correspondingly increases.

Accordingly it is beneficial to provide an information gathering systems, methods, and programs in which, for example, by solving one or more of the problems of the foregoing conventional navigation apparatuses, the cost for information gathering can be reduced, and execution of unnecessary communications will be avoided.

Accordingly, various exemplary implementations of the principles described herein provide information gathering systems, methods, and programs that transmit a request for other-vehicle drive information to an information center; and as a result of the transmitted request, only receive other-vehicle drive information of vehicles that are within a predetermined area, the predetermined area set based on the present location.

Various exemplary implementations of the principles described herein provide information gathering systems, methods, and programs determine whether a link corresponding to a present location is subject for gathering drive information and, if the link corresponding to the present location is subject for gathering the drive information, gather the drive information for that link.

### BRIEF DESCRIPTION OF THE DRAWINGS

FIG. 1 shows a navigation system according to an exemplary implementation of the principles described herein;

FIG. 2 shows a method of gathering and transmitting information according to an exemplary implementation of the principles described herein;

FIG. 3 shows an example of a designated area; and

FIG. 4 shows a method of gathering and transmitting information according to an exemplary implementation of the principles described herein.

### DETAILED DESCRIPTION OF EXEMPLARY IMPLEMTATIONS

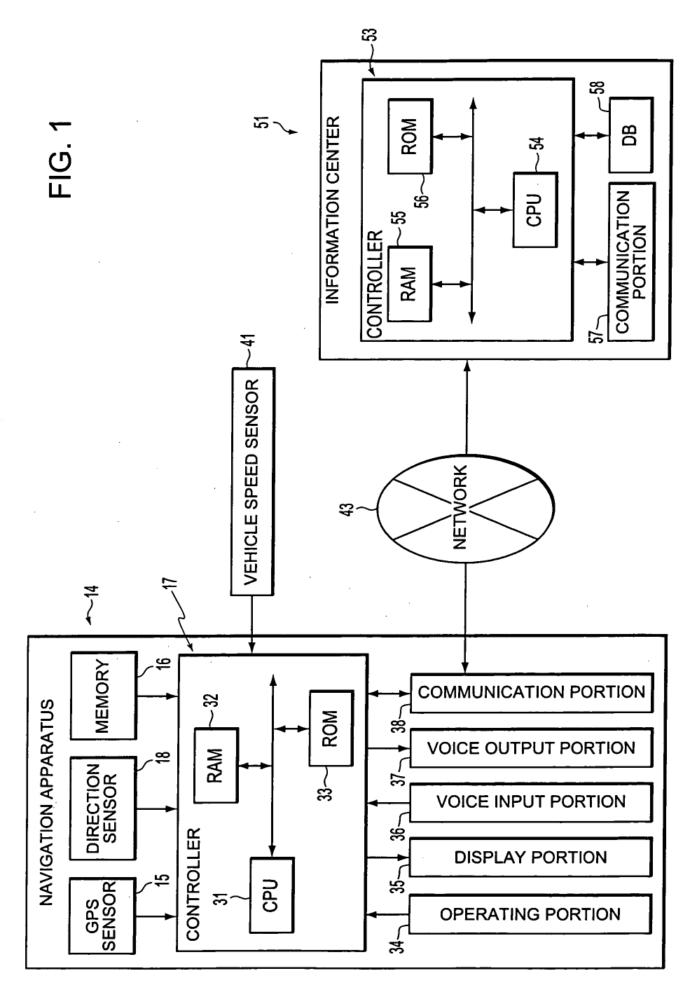

FIG. 1 shows a conceptual block diagram representing an exemplary navigation system. As shown in FIG. 1, the navigation system may include an information terminal, for example, a vehicle-mounted navigation apparatus 14. The navigation apparatus 14 may include, for example a GPS sensor 15 that, for example, detects the present location and a memory 16, for example, in which various information such as map data is recorded. The navigation apparatus 14 may include a controller 17, for example, that performs various computational processes such as navigation processes on the basis of input information; a direction sensor 18, for example, that detects the direction of the vehicle; and an operating portion 34, for example, that receives inputs from a user. The navigation apparatus 14 may include a display portion 35, for example, that displays images on a screen (not shown); a voice input portion 36, for example, that receives input via voices or the like; and a voice output portion 37, for example, that makes various audible indications to give a notification to a user. The navigation apparatus 14 may include a communication portion 38, for example, that functions as a communication terminal. The operating portion 34, the display portion 35, the voice input portion 36, the voice output portion 37 and the communication portion 38 may be, for example, connected to the controller 17. Furthermore, a vehicle speed sensor 41 may also be connected to the controller 17.

The GPS sensor 15 may detect the present location on the earth and, in addition, may receive the time of day via radio waves generated by an artificial satellite. As discussed above, he GPS sensor 15 may be used to detect a present location. However, instead of the GPS sensor 15, it is also possible to use a distance sensor, a steering sensor, an altimeter, etc. (not shown) individually or in combination to detect a present location. Furthermore, as the direction sensor 18, it is possible to use, for example, a gyro sensor, a geomagnetic sensor, etc.

The memory 16 may be provided with a map database that is made up of map data, fin the form of, for example, files. Map data may be recorded in the map database. Note that data for outputting predetermined information via the voice output portion 37 may also be recorded in the memory 16. The map data may include, for example, intersection data regarding intersections, node data regarding nodes, road data regarding road links, search data manipulated for search, and/or facility data regarding facilities.

According to this example, the term “link” refers to, for example, a road or portion of a road. For example, according to one type of map data, each road may consist of a plurality of componential units called links. Each link may be separated and defined by, for example, an intersection, an intersection having more than three roads, a curve, and/or a point at which the road type changes. As used herein the term “node” refers to a point connecting two links. A node may be, for example, an intersection, an intersection having more than three roads, a curve, and/or a point at which the road type changes.

The controller 17 may include, for example, a CPU 31 that, for example, controls the navigation apparatus 14, a RAM 32 that, for example, is used as a working memory to aid the CPU 31 in performing various processes, and/or a ROM 33 that, for example, stores instructions or programs for control, for the search of a route to a destination and/or, for route guidance. In addition to the ROM 33, a flash memory (not shown) may alternatively or additionally store various data and/or programs. Note that, in addition to or instead of the CPU 31, an MPU (not shown) or the like may be used.

The memory 16 may be provided with a disk (not shown), such as, for example, a hard disk, a CD, a DVD, a memory card, and/or an optical disk in order to record the aforementioned various data. In addition, the memory 16 may also be provided with a head (not shown), such as a read-write head or the like, for reading and writing various data.

Although it is possible to record various programs in the ROM 33 and record various data in the memory 16, it is also possible to record, for example, programs and/or data on an removable disk. In this case, various programs and/or data may be read out from the disk and written into a flash memory. As a result, the various programs and/or data can be updated by changing the disk. Furthermore, if an automatic transmission control device is mounted in the vehicle in order to perform the control of an automatic transmission mounted (not shown) in the vehicle, the programs and/or data for the automatic transmission control device may also be recorded on the removable disk. It is also possible to receive various programs and/or data via the communication portion 38 and then write them into a flash memory.

The operating portion 34 may be used to correct the present location at the time of starting to drive the vehicle, to input a starting location and a destination, to input waypoints, and/or to operate the communication portion 38. A keyboard, and/or a mouse that are provided independently of the display portion 35 may be used as the operating portion 34. Furthermore, as the operating portion 34, it is also possible to use a touch panel such that predetermined input operations may be carried out by touching or clicking image operating portions, such as various keys, switches, and/or buttons that are displayed as images on the screen formed in the display portion 35.

As the display portion 35, a display device may be used. It is possible to display, on various screens formed in the display portion 35, the vehicle's position representing the present location, maps, search routes, guidance information along search routes, and/or traffic information. It is possible to display, on various screens formed in the display portion 35 the distance to an intersection on a search route and/or the driving direction at the intersection. Moreover, it is possible to display, for example, operation guidance, the operating portion 34, the voice input portion 36, operation menus, guidance on keys, and/or FM multiple broadcast programs and the like.

The voice input portion 36 may be structured of a microphone (not shown) so that necessary information can be input by voice. The voice output portion 37 may be provided with a voice synthesizer device and a speaker (not shown), so that the voice output portion 37 may output search routes, guidance information, and/or traffic information by, for example, audio in the form of voices synthesized by the voice synthesizer device.

The communication portion 38 may be provided with, for example, a beacon receiver and/or an FM receiver. The beacon receiver may receive various information transmitted from a road traffic information center (not shown), such as the VICS® (Vehicle Information and Communication System) center or the like. Such various information may be transmitted as radio wave beacons and/or light beacons via, for example, radio beacon devices and/or light beacon devices that are disposed along roads. The FM receiver may receive such various information as, for example, an FM multiple broadcast program via an FM broadcasting station.

It is possible to receive, via, for example, the beacon receiver, traffic information, such as, for example, congestion information, regulation information, parking space information, traffic accident information, and/or information regarding the congestion of service areas. It is possible to receive, for example, news and/or weather reports in addition to the traffic information, via the FM receiver. Note that, according to this example, although the beacon receiver and the FM receiver are combined as a single unit in the form of a VICS receiver, they may be disposed separately.

The congestion information may include the distance between the beginning and end of the congestion, the congestion degree of each link, and/or a time that is a required to travel each link, for example, based on the congestion.

The communication portion 38 may also receive various information, such as, for example, traffic information, news, and/or weather reports from an information center 51. Accordingly, the communication portion 38 and the information center 51 may be connected via a network 43.

The navigation apparatus 14, the road traffic information center, the information center 51, the network 43, for example, may constitute the navigation system, and various information may be transmitted and received between the communication portion 38 and a communication portion 57 of the information center 51.

The network 43 may be wired and/or wireless and may include, for example, communication lines, such as a local area network (LAN), a wide area network (WAN), and/or the Internet.

The information center 51 may be provided with a controller 53, the communication portion 57, and/or a memory in the form of, for example a database (DB) 58. The controller 53 may be provided with, for example, a CPU 54, a RAM 55, and/or a ROM 53. The controller 53 may function as a processing unit on the basis of various programs and/or data. Furthermore, data substantially the same as the various data recorded in the memory 16 can be recorded in a database 58. Furthermore, an MPU or the like may be used instead of the CPU 54.

A statistical database made up of, for example, statistical data files, a travel history database made up of travel history data files, and/or general information database made up of general information data files, may also be included in the memory 16 and/or database 58. Statistical information may be recorded in the statistical data files, travel history data may be recorded in the travel history data files, and general data may be recorded in the general information data files.

The statistical data may include the history of traffic information, such as, for example, traffic congestion information, provided in the past. The statistical data may be generated by using at least one of, for example, traffic information, data representing the amount of traffic, and/or road timetable information, and by performing statistical processing thereon. The traffic information may be provided by, for example, the road traffic information center. The data representing the amount of traffic may be based on, for example, the road traffic census provided by the National Land and Transportation Ministry of Japan (hereinafter, referred to as “road traffic census information”). The road timetable information may be provided by the National Land and Transportation Ministry of Japan, and may include data representing, for example, the relationship between the time of day and the traffic congestion degree.

The data items of the statistical data may include, for example, link number data (ID) regarding various road links Lᵢ (i=1, 2, . . . , N) constituting routes through which the vehicle has been driven in the past; a direction flag representing the driving direction; information classification for representing whether a piece of information belongs to either the traffic information provided by the road traffic information center or the road traffic census information; and/or the congestion degree KJᵢ(t) (i=1, 2, . . . , N) as a congestion index that represents the degree of congestion determined every predetermined timing t, for example, every 15 minutes. Note that the congestion degree KJᵢ(t) may be represented by the classifications of a congested state, a crowded state, and a non-congested state.

The travel history data may include data representing the drive information regarding the driven route of the vehicle, that is, probe data. The travel history data may include vehicle travel history data that is travel history data representing the drive information regarding the driven routes of the vehicle; and other vehicle travel history data that is travel history data representing drive information regarding the driven routes of other vehicles.

The data items of the travel history data may include, for example, the link required time STᵢ(t) (i=1, 2, . . . , N) representing the time required to travel a link determined in a predetermined cycle, for example, every 15 minutes, during the drive through each road link Lᵢ; and/or the congestion degree SJᵢ(t) (i=1, 2, . . . , N) determined every predetermined timing t, for example, every 15 minutes, during the drive through each road link Lᵢ. The link required time STᵢ(t) may be calculated on the basis of a plurality of past drive information.

The general data may include general information that can be factors that cause congestions, such as, for example, information regarding various events or facilities (the presence/absence of large facilities, such as railway stations, department stores, and/or supermarkets) as well as the date, the day of week, seasons, and/or weather.

Note that the map database, the statistical database, the travel history database, and/or the general database may be formed in the memory 16 so that the map data, the statistical data, the travel history data, and/or the general data may be recorded. The map data and the statistical data may be pre-recorded on a disk that is set in the memory 16. Of the travel history data, the vehicle's travel history data may be recorded in the memory 16, on the basis of the drive information of the vehicle. To that end, the CPU 31 may perform a vehicle drive information gathering process, in which as the vehicle is driven, the link required time STᵢ(t) and/or the congestion degree SJᵢ(t) are computed and are recorded in the memory 16. Of the travel history data, the other vehicle travel history data may be transmitted from the information center 51, may be received via the communication portion 38, and may be recorded in the memory 16. To that end, the CPU 31 may performs other vehicle drive information gathering process, in which the link required time STᵢ(t) and/or the congestion degree SJᵢ(t) are received as other vehicle drive information via the communication portion 38, and are recorded in the memory 16.

The general data may be transmitted from the information center 51, may be received via the communication portion 38, and may be recorded in the memory 16. To that end, the CPU 31 may performs a general information acquiring process, in which the general data is received by the communication portion 38, and is recorded in the memory 16. Of the general data, the information regarding various events and/or facilities may be pre-recorded in the memory 16.

The statistical data, the travel history data and/or the general data may be separately generated and recorded in the respective statistical database, the travel history database and/or the general database. However, at least one of the travel history data and the general data may be combined and used together with the statistical data, and may also subjected to a statistical process, so that it becomes statistical data.

Furthermore, the map data and the statistical data may also be transmitted from the information center 51, may be received via the communication portion 38, and may be recorded in the memory 16. To that end, the CPU 31 may performs a map information gathering process, in which the map data is received by the communication portion 38, and is recorded in the memory 16. The CPU 31 may perform a statistical information gathering process, in which the statistical data is received by the communication portion 38, and is recorded in the memory 16. The general data may also be transmitted from the road traffic information center.

The other vehicle travel history data and/or the general data, which have been received, are recorded in the memory 16. However, those data may also be or alternatively be recorded in a flash memory, for example, in or connected to the controller 17.

Note that the navigation apparatus 14 may be designed so as to be able to directly receive present-state traffic information from the road traffic information center via the communication portion 38. To that end, the CPU 31 may perform a traffic information acquiring process, in which present-state traffic information is received by the communication portion 38, and is therefore acquired.

The present-state traffic information received from the road traffic information center may include, for example, information classification data representing classifications of information; secondary mesh X-Y data for specifying a secondary mesh (of approximately 10 km×10 km grid) that is used as a mesh overlay on the map data; link number data that specifies road links Lᵢ and may include inbound-outbound distinction; and/or link information representing the content of information provided corresponding to the link number data. The link information may include, for example, congestion start data representing the distance from the starting point of a road link Lᵢ to the beginning of traffic congestion, congestion degree data representing the congestion degree VJᵢ (i=1, 2, . . . , N), and/or congestion length data representing a congestion section by the congestion length (distance) between the beginning and end of the congestion.

The congestion degree VJᵢ may be used as a congestion index that represents the degree of congestion, and may be represented by the classifications of a congested state, a crowded state and a non-congested state. The present-state traffic information transmitted from the road traffic information center may be received. The present-state traffic information transmitted from the information center 51 can also be received. In that case, the information center 51 may receive the present-state traffic information transmitted from the road traffic information center, and may send it to the navigation apparatus 14 immediately or after performing a statistical process.

In operation, the navigation apparatus 14 may be started upon the operation of the operating portion 34, the CPU 31 may perform a navigation initializing process, in which the present location detected by the GPS sensor 15 and the vehicle's direction detected by the direction sensor 18 are input, and various data are initialized. Note that the CPU 31 may performs a matching process, in which the present location is identified by determining on which one of the road links the present location is, on the basis of, for example, the present location, and/or the shapes and arrangements of the road links constituting surrounding roads.

Subsequently, the CPU 31 may perform an information acquiring process, in which the map data is read out from the memory 16, and is thus acquired. The CPU 31 may then perform a displaying process, in which a map screen is formed in the display portion 35, and, for example, the vehicle position, a map around the vehicle position and the vehicle direction are displayed on the map screen. Therefore, the driver can drive the vehicle in accordance with the vehicle position, the map around the vehicle position and the vehicle direction that are displayed.

Furthermore, if a destination is input by operating the operating portion 34, the CPU 31 may perform a destination setting process, in which a destination is set. Note that it is also possible to input and set a starting location that is different form the present location of the vehicle. Furthermore, it is also possible to register predetermined location points beforehand, and input a registered location point as a destination.

After the destination is set, the CPU 31 may perform a route search process, in which the present location and/or the destination are input, and a route from the starting point represented by the present location to the destination is searched for, on the basis of the present location, the destination, and the map data. In this case, it is possible to search for a route on the basis of the present-state traffic information and, furthermore, on the basis of traffic information, such as the statistical data and/or the travel history data, in addition to the destination and the map data.

Then, the CPU 31 may perform a route guidance process, in which route guidance is performed in accordance with the searched route. To that end, the CPU 31 may perform a route displaying process, in which the route data regarding the searched route is input, and the searched route is displayed on the map screen in accordance with route data. The CPU 31 may also perform a voice output process, in which the search route is output by voices from the voice output portion 37.

As described above, the navigation apparatus 14 may receive the present-state traffic information from the road traffic information center via the communication portion 38. Accordingly, the CPU 31 acquires the present-state traffic information.

As described above, the statistical database and the travel history database may be formed in the memory 16. Congestion degree KJᵢ(t) may be recorded as statistical data in the statistical data files constituting the statistical database. The link required time STᵢ(t) and/or the congestion degree SJᵢ(t) are recorded as travel history data in the travel history data files constituting the travel history database. Then, the CPU 31 acquires statistical data and travel history data by reading them from the memory 16.

Thus, the CPU 31 is able to acquire a plurality of types of traffic information, that is, for example, the present-state traffic information, the statistical data, and/or the travel history data. Hence, the CPU 31 may perform a traffic information displaying process, in which, for example, a congestion degree VJᵢ for the acquired present-state traffic information, and a congestion degree SJᵢ(t) for the travel history data, and a congestion degree KJᵢ(t) for the statistical data are selected as congestion information. On the basis of the congestion information, a congestion arrow as a traffic situation index that represents a congestion situation may be generated, and the congestion arrow may be displayed along the road in the map screen.

Therefore, it is possible for the driver to know the situation of congestion on the search route. Note that the color of the congestion arrow may be changed to red, orange, blue, etc. in accordance with the congestion degrees SJᵢ(t), KJᵢ(t), VJᵢ. For example, the arrow may be turned red in the case of a congested state, orange in the case of a crowded state, and blue in the case of a non-congested state. Furthermore, the congestion arrow can be displayed in different patterns in accordance with the congestion degree SJᵢ(t), KJᵢ(t), VJᵢ. For example, the congestion arrow may be displayed in a solid-line pattern in the case of a congested state, and a broken-line pattern in the case of a crowded state.

Furthermore, while driving the vehicle, the CPU 31 may computes the link required time STᵢ(t) and/or the congestion degree SJᵢ(t) as vehicle drive information, and may records them in the memory 16, as the vehicle is driven.

Note that the above-structured navigation system may be used as an information gathering system. With regard to a pre-selected vehicle, the navigation system may be designed so that the coordinates and the vehicle speed thereof can be input, for example, every 1 sec, along the road on which the vehicle is being driven, and the coordinates and the vehicle speed can be transmitted to the information center 51 as drive information related to the vehicle. Then, the information center 51 may gather drive information, perform a statistical process on the gathered drive information, and computes the link required time STᵢ(t) and/or the congestion degree SJᵢ(t). The information center may then provide the link required time STᵢ(t) and/or the congestion degree SJᵢ(t), which have been computed, to various other vehicles as other vehicle drive information.

As discussed above, conventional systems are designed so that the other vehicle drive information is gathered irrespective of whether the driver of a particular vehicle uses the provided other vehicle drive information. Accordingly, the communication expense for sending the drive information to the information center 51 becomes high, and therefore the cost for information gathering becomes high. Furthermore, unnecessary communications are executed.

According to this example, however; only when a vehicle requests to acquire other vehicle travel history data, another vehicle within a predetermined area where the predetermined vehicle is being driven transmits and thus provides drive information to the information center 51. As a result vehicles do not unnecessarily transmit drive information when no vehicles are requesting it.

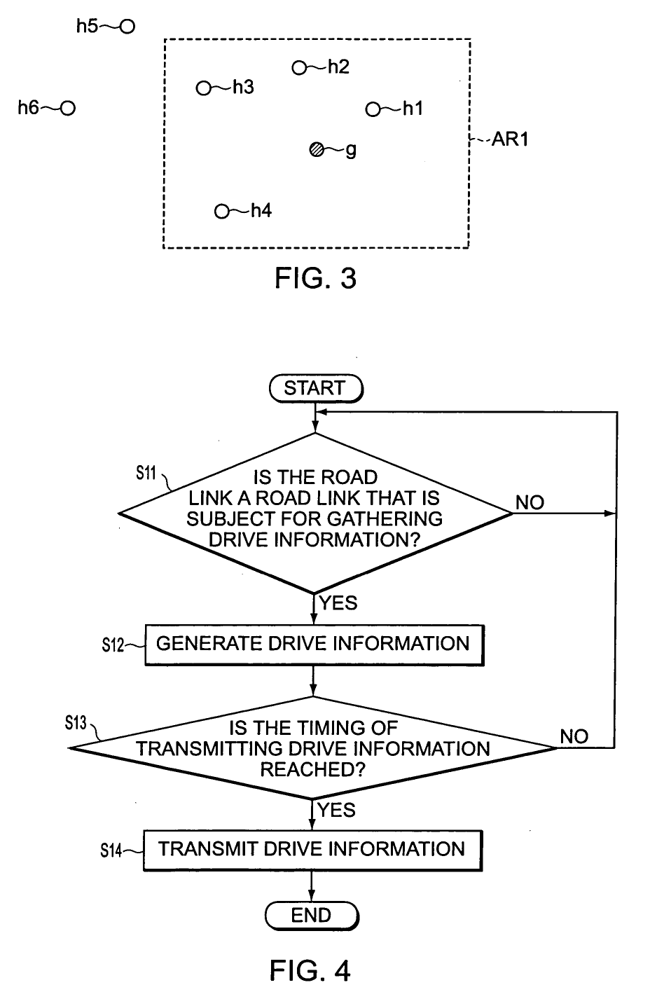

For example, as shown in FIG. 3, a vehicle g may request to acquire other vehicle travel history data. Reference character hi (i=1, 2, . . . N) represents other nearby vehicles. In this case, of the vehicles hi, the ones that are within a predetermined range AR1 surrounding vehicle g, with the vehicle g being at a center of the area AR1, are drive information-providing vehicles hm (m=1 to 4) that transmit and provide drive information to the information center 51. Note that, in this case, the vehicle g and the vehicles hi are assumed to have functions of transmitting drive information to the information center 51.

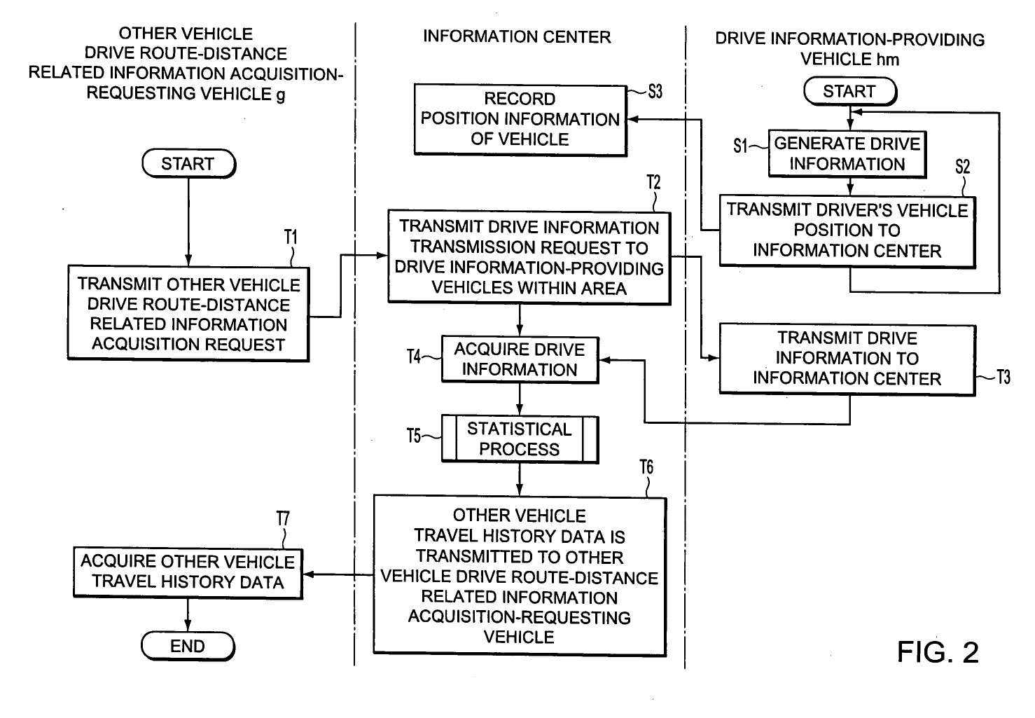

One example of a method for gathering and transmitting data is shown in FIG. 2. The exemplary method may be implemented, for example, by one or more components of the above-described navigation system. However, even though the exemplary structure of the above descried navigation system is referenced in the description, it should be appreciated that the structure is exemplary and the exemplary method need not be limited by any of the above-described exemplary structure.

First, in each vehicle g, hi, the CPU 31 performs a drive information generating process, in which the coordinates and the vehicle speed are determined every 1 sec, and the coordinates and the vehicle speed are stored as drive information of the vehicle in the RAM 32 (step S1).

Note that, according to this example, the coordinates and the vehicle speed may be obtained every 1 sec are set as drive information of the vehicle. However, the CPU 31 may input the coordinates of a predetermined node on each road link, and input a time needed for the driving between predetermined nodes (between every two nodes or between nodes that are a few nodes apart from each other), that is, a node required time, and set the coordinates and the node required time as drive information. The CPU 31 may also measure an actual link required time needed for driving a road link and set the road link number and the actual link required time as drive information. The CPU 31 may also input vehicle speed during the passage through a road link and compute an average vehicle speed on the road link, and set the road link number and the average vehicle speed as drive information.

Furthermore, in each vehicle g, hi, the CPU 31 may perform a position information transmitting process, in which at every 1 sec, the present location detected by the GPS sensor 15 is input, and the coordinates of the present location are transmitted to the information center 51 as position information (Step S2).

Then, in the information center 51, the CPU 54 may perform a position information recording process, in which when the vehicle position is received from each vehicle hi, and the vehicle position is recorded as position information in the database 58 (Step S3).

On the other hand, in the navigation apparatus 14 of the vehicle g, if the the operating portion 34 is operated in order to use other vehicle history data, the CPU 31 performs an other vehicle drive information acquisition requesting process, in which an other vehicle drive information acquisition request is generated, and is transmitted to the information center 51 (step T1).

Upon receiving the other vehicle drive information acquisition request in the information center 51, the CPU 54 may perform a drive information gathering process, in which the drive information of the drive information-providing vehicles hm among the vehicles hi is gathered on the basis of the other vehicle drive information acquisition request. To that end, the CPU 54 performs an area setting process, in which the area AR1 is set on the basis of the present location of the vehicle g. The CPU 54 performs a vehicle determining process, in which the position information of the vehicles hi is read out from the database 58 and, on the basis of the position information and the coordinates that specify the area AR1, it is determined with regard to each vehicle hi whether the vehicle is being driven within the area AR1.

If a predetermined vehicle of the vehicles hi is being driven within the area AR1, the vehicle being driven within the area AR1 is specified as a drive information-providing vehicle hm. Subsequently, the CPU 54 performs a drive information transmission request process, in which the drive information transmission request is transmitted to the drive information-providing vehicle(s) hm (step T2).

Then, in each drive information-providing vehicle hm, when the CPU 31 receives the drive information transmission request, the CPU 31 performs a drive information transmitting process, in which the drive information is read out from the RAM 32, and is transmitted to the information center 51 (step T3). Note that, although the recording and reading of drive information may be performed on the RAM 32, the recording and reading may also be performed on the memory 16.

Then, in the information center 51, the CPU 54 performs a drive information acquiring process, in which the drive information transmitted from each drive information-providing vehicle hm is acquired, and is recorded in the database 58 (Step T4).

Subsequently, in the information center 51, the CPU 54 performs a statistical process (Step T5), in which a statistical process is performed on the received drive information, and the link required time STᵢ(t) and/or the congestion degree SJᵢ(t) are computed. The link required time STᵢ(t), the congestion degree SJᵢ(t), which have been computed, are recorded in the database 58 as other vehicle travel history data. Then, the CPU 54 performs an other vehicle travel history data providing process, in which the other vehicle travel history data is read out from the database 58, and is transmitted to the vehicle g (step T7).

Then, in the vehicle g, the CPU 31 may perform an other vehicle travel history data recording process, in which the other vehicle travel history data is acquired, and is recorded in a travel history data file.

Thus, when the vehicle g requests acquisition of other vehicle travel history data, each drive information-providing vehicle hm being within a predetermined area AR1 of the vehicle g transmits drive information to the information center 51, and thus provides the requested information. Therefore, the vehicle g can acquire the other vehicle travel history data in real time.

That is, since drive information is gathered only when a driver uses other vehicle travel history data, the communication expense of sending drive information to the information center 51 can be reduced, so that the cost for information gathering can be reduced. Furthermore, the execution of unnecessary communication will be avoided.

According to this example, the area AR1 is set so as to have a rectangular shape. However, the area may be set so as to have a circular shape of a predetermined radius with the vehicle g at the center. Still further, the area A1 may be set as an area along the search route.

FIG. 4 shows another example of a method for gathering and transmitting data. The exemplary method may be implemented, for example, by one or more components of the above-described navigation system. However, even though the exemplary structure of the above descried navigation system is referenced in the description, it should be appreciated that the structure is exemplary and the exemplary method need not be limited by any of the above-described exemplary structure.

According to this example, the navigation apparatus 14 may generates drive information only with regard to roads that are subjects for gathering drive information (such as, for example, roads with high possibilities of occurrence of a congestion and/or roads whose congestion information is highly demanded) of the roads on which the vehicle is driven, on the basis of the present location, and may transmit the generated drive information to the information center 51. That is, the CPU 31 may performs a road link determining process, in which drive information is generated only with regard to road links with high possibility of occurrence of a congestion or roads whose congestion information is highly demanded, of the road links through which the vehicle passes, and is transmitted to the information center 51. For example, the CPU 31 determines whether a road link through which the vehicle passes during the drive is a road link that is a subject for gathering drive information, for example, on the basis of whether at least one of the following determination conditions is met.

The CPU 31 may perform a road determining process, in which it is determined whether a road on which the vehicle is driven is a road that is a subject for gathering drive information, for example, on the basis of the present location (Step S11). If the road on which the vehicle is driven is a road that is a subject for gathering drive information (Step 11=Yes), the drive information is generated with regard to that road (Step S12).

To that end, for example, the CPU 31 may input present-state traffic information, and determine whether a road link through which the vehicle passes is a road link where a regulation due to a road work or the like is scheduled, on the basis of the regulation information in the present-state traffic information. If the road link through which the vehicle passes is a road link with a scheduled regulation, it is determined that the first determination condition is met. If it is not a road link with a scheduled regulation, it is determined that the first determination condition is not met.

The CPU 31 may read general data, and determine whether a road link through which the vehicle passes is a road link that is within a region under an unusual weather with an alarm, a warning or the like issued regarding the weather, on the basis of the information about weather in the general data. If the road link through which the vehicle passes is a road link that is within a region under an unusual weather, it is determined that the second determination condition is met. If it is not a road link that is within a region under an unusual weather, it is determined that the second determination condition is not met.

Then, the CPU 31 may read general data, and determine whether a road link through which the vehicle passes is a road link that is within a region where an event, such as a fireworks exhibition or the like, is held, on the basis of the event information in the general data. If the road link through which the vehicle passes is a road link within a region where an event is held, it is determined that the third determination condition is met. If it is not a road link within a region where an event is held, it is determined that the third determination condition is not met.

Next, the CPU 31 may read general data, and determine whether a road link through which the vehicle passes is a road link that is within a region with a large-scale facility in the neighborhood, on the basis of the information about facilities in the general data. If the road link through which the vehicle passes is a road link that is within a region with a large-scale facility in the neighborhood, it is determined that the fourth determination condition is met. If it is not a road link that is within a region with a large-scale facility in the neighborhood, it is determined that the fourth determination condition is not met.

The CPU 31 may determine whether a road link through which the vehicle passes is a road link that is not a subject for the provision of present-state traffic information by the road traffic information center, that is, a non-information providing road link. If the road link through which the vehicle passes is a non-information providing road link, it is determined that the fifth determination condition is met. If it is not a non-information providing road link, it is determined that the fifth determination condition is not met.

The CPU 31 may input the vehicle speed as the vehicle passes through the road link, and determine whether there is a difference of a predetermined value or greater, for example, 20 km/h or greater, between the vehicle speed and an average vehicle speed that is included in the static traffic information, such as the road traffic census information or the like. If there is a difference of the predetermined value or greater between the vehicle speed and the average vehicle speed, it is determined that the sixth determination condition is met. If there is not a difference of the predetermined value or greater therebetween, it is determined that the sixth determination condition is not met.

Then, the CPU 31 determines whether a road link through which the vehicle passes is a road link that is within a region that has been selected beforehand as a site where a congestion is likely to occur, on the basis of, foe example, a survey such as a questionnaire or the like. If the road link through which the vehicle passes is a road link that is within such a pre-selected region, it is determined that the seventh determination condition is met. If it is not a road link that is within such a pre-selected region, it is determined that the seventh determination condition is not met.

Then, for example, if at least one determination condition of the first to seventh determination conditions is met, the CPU 31 determines that the road link through which the vehicle passes is a road link that is a subject for gathering drive information (Step S11=Yes). If none of the first to seventh determination conditions is met, the processing portion determines that the road link through which the vehicle passes as the vehicle is driven is a road link that is not a subject for gathering drive information (Step S11=No).

Subsequently, the CPU 31 performs a drive information generating process, in which if a road link through which the vehicle passes as the vehicle is driven is a road link that is a subject for gathering drive information (Step S11=Yes), the coordinates and the vehicle speed are input every elapse of 1 sec, and the coordinates and the vehicle speed are arranged as drive information of the vehicle, as described above (Step S12).

Note that, according to this example, the coordinates and the vehicle speed obtained every elapse of 1 sec are set as drive information of the vehicle. However, the drive information generation processing portion may be designed to input the coordinates of a predetermined node on each road link, and input a time needed for the driving between predetermined nodes (between adjacent nodes or between nodes that are a few nodes apart from each other), that is, a node required time, and set the coordinates and the node required time as drive information, may be designed to measure an actual link required time needed for actually driving through a road link and set the road link number and the actual link required time as drive information, and/or may be designed to input vehicle speed during the passage through a road link and compute an average vehicle speed on the road link, and set the road link number and the average vehicle speed as drive information.

Subsequently, the CPU 31 performs a drive information transmitting process, in which the time of day is input, and it is determined whether a pre-set transmission timing for the drive information is reached (Step S13), and if the transmission timing of the drive information is reached (Step S13=Yes), the drive information is transmitted to the information center 51 (Step S14).

In this example, the drive information is successively transmitted, and the CPU 31 may transmit the drive information immediately upon generation thereof. However, the drive information may be transmitted after the elapse of a predetermined time, for example, 5 min, following the generation thereof, or may be transmitted periodically, for example, every elapse of 10 min.

Then, in the information center 51, the CPU 54 performs a drive information gathering process, in which the drive information transmitted from the navigation apparatus 14 is received via the communication portion 57, and the CPU 54 computes the link required time STᵢ(t) and/or the congestion degree SJᵢ(t) on the basis of the drive information received, and records the link required time STᵢ(t) and/or the congestion degree SJᵢ(t), which have been computed, in the database 58. Then, the CPU 54 performs a drive information providing process, in which the link required time STᵢ(t) and/or the congestion degree SJᵢ(t) are transmitted as other vehicle drive information to the navigation apparatus 14 of a predetermined vehicle.

Thus, in this example, the drive information is generated only with regard to the roads or road links having a high possibility of occurrence of a congestion and/or the roads or road links whose congestion information is highly demanded, among the roads through which the vehicle is driven or the road links which through the vehicle passes. Therefore, the communication expense for transmission of the drive information from the navigation apparatus 14 to the information center 51 can be reduced. Furthermore, the amount of calculation for performing statistical processes at the information center 51 reduces, so that a high-performance processing device for the calculation becomes unnecessary. Thus, the cost for information gathering can be reduced.

Even if drive information is to be gathered from a very large number of vehicles in order to gather real-time drive information with regard to all the roads, the cost for information gathering can be reduced.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An information terminal, comprising:
a present location detector that detects a present location; and
a controller that:
generates drive information during the driving of a vehicle;
transmits the present location to an information center;
transmits a request for other-vehicle drive information to the information center; and
as a result of the transmitted request, receives other-vehicle drive information of a vehicle that is within a predetermined area, the predetermined area set based on the present location.

2. The information terminal of claim 1, wherein the drive information includes at least one of:
the vehicle coordinates; and
the vehicle speed.

3. The information terminal of claim 1, wherein the other-vehicle drive information includes at least one of:
a link required time; and
a congestion degree.

4. The information terminal of claim 1, wherein the controller:
receives a drive information transmission request; and
in response to the request, transmits the generated drive information to the information center.

5. The information terminal of claim 1, wherein the controller:
receives a drive information transmission request when the terminal is within a predetermined area of a vehicle making a request for other-vehicle drive information.

6. The information terminal of claim 1, wherein the controller:
determines whether a link corresponding to the present location is subject for gathering the drive information; and
if the link corresponding to the present location is subject for gathering the drive information, gathers the drive information for that link.

7. The information terminal of claim 6, wherein the controller determines whether the link corresponding to the present location is subject for gathering the drive information based on at least one of:
whether the link has road work;
whether the link is in a region under a weather alarm;
whether the link is in a region where an event is taking place;
whether the link is in a region with a large-scale facility;
whether present-state traffic information is available for the link;
whether there is a difference of a predetermined value or greater, between the vehicle speed and an average vehicle speed; and
whether the link is within a region that has been selected beforehand as a region where traffic congestion is likely to occur.

8. The information terminal of claim 1, wherein the information terminal is a navigation apparatus.

9. An information center, comprising:
a controller that:
receives the present location of a vehicle making a request for other-vehicle drive information;
transmits a request for the other-vehicle drive information to a vehicle within a predetermined area, the predetermined area set based on the present location;
receives the other-vehicle drive information from the vehicle within the predetermined area; and
transmits the received other-vehicle drive information to the vehicle making the request for the other-vehicle drive information.

10. The information center of claim 9, wherein the controller:
specifies the vehicle within the predetermined area; and
transmits the request for the other-vehicle drive information to the specified vehicle.

11. The information center of claim 9, wherein the controller:
receives the other-vehicle drive information in the form of at least one of the coordinates of the vehicle within the predetermined area and the speed of the vehicle within the predetermined area; and
transmits the received other-vehicle drive information in the form of at least one of a link required time and a congestion degree.

12. An information gathering and transmitting method, comprising:
detecting a present location;
generating drive information during the driving of a vehicle;
transmitting the present location to an information center;
transmitting a request for other-vehicle drive information to the information center; and
receiving, as a result of the transmitted request, other-vehicle drive information of a vehicle that is within a predetermined area, the predetermined area set based on the present location.

13. The information gathering and transmitting method of claim 12, wherein generating the drive information during the driving of the vehicle comprises at least one of determining the vehicle coordinates and determining the vehicle speed.

14. The information gathering and transmitting method of claim 12, further comprising:
receiving a drive information transmission request; and
transmitting, in response to the request, the generated drive information to the information center.

15. The information gathering and transmitting method of claim 14, wherein:
receiving the drive information transmission request comprises receiving the drive information transmission request when the vehicle is within a predetermined area of a vehicle making a request for other-vehicle drive information.

16. The information gathering and transmitting method of claim 12, further comprising:
determining whether a link corresponding to the present location is subject for gathering the drive information; and
gathering, if the link corresponding to the present location is subject for gathering the drive information, the drive information for that link.

17. The information gathering and transmitting method of claim 16, wherein determining whether the link corresponding to the present location is subject for gathering the drive information comprises at least one of:
determining whether the link has road work;
determining whether the link is in a region under a weather alarm;
determining whether the link is in a region where an event is taking place;
determining whether the link is in a region with a large-scale facility;
determining whether present-state traffic information is available for the link;
determining whether there is a difference of a predetermined value or greater, between the vehicle speed and an average vehicle speed; and
determining whether the link is within a region that has been selected beforehand as a region where traffic congestion is likely to occur.

18. The information gathering and transmitting method of claim 12, wherein receiving the drive information of the vehicle that is within the predetermined area comprises receiving at least one of a link required time and a congestion degree.

19. A storage medium storing a set of program instructions executable on a data processing device and usable to gather and transmit information according to the method of claim 12.
